(19) United States
(12) Patent Application Publication
(10) Pub. No.: US 2019/0370846 A1
(43) Pub. Date: Dec. 5, 2019

(54) SERVICE PROCESSING METHOD, STORAGE MEDIUM, AND TERMINAL

(71) Applicant: Tencent Technology (Shenzhen) Company Limited, Shenzhen (CN)

(72) Inventor: Wen ZHA, Shenzhen (CN)

(21) Appl. No.: 16/545,912

(22) Filed: Aug. 20, 2019

Related U.S. Application Data
(63) Continuation of application No. PCT/CN2018/081238, filed on Mar. 30, 2018.

(30) Foreign Application Priority Data
May 12, 2017 (CN) 201710334832.0
May 12, 2017 (CN) 201710334834.X

(51) Int. Cl. G06Q 30/02; G06K 19/06; G06Q 50/00

(52) U.S. Cl. CPC G06Q 30/0226; G06Q 50/01; G06K 19/06037; G06K 19/06028

(57) ABSTRACT

A service processing method includes: obtaining card or voucher information and a sharing initiator identifier when receiving a request for sharing a card or voucher from a user of a social network application; obtaining a list of associated users of the social network application, the list of associated users including each piece of user information having an association with the sharing initiator identifier and being friends of the user; obtaining a sharer identifier selected by using the list of associated users; and sending the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

### CROSS-REFERENCE TO RELATED APPLICATIONS

This application is a continuation application of PCT/CN2018/081238, entitled “SERVICE PROCESSING METHOD, STORAGE MEDIUM, AND TERMINAL” filed on Mar. 30, 2018, which claims priority to (i) Chinese Patent Application No. 201710334834.X, filed with the Chinese Patent Office on May 12, 2017 and entitled “SERVICE PROCESSING METHOD AND APPARATUS, COMPUTER DEVICE, AND STORAGE MEDIUM” and (ii) Chinese Patent Application No. 201710334832.0, filed with the Chinese Patent Office on May 12, 2017 and entitled “MEMBERSHIP CARD SHARING METHOD AND APPARATUS, COMPUTER DEVICE, AND STORAGE MEDIUM”, all of which are incorporated by reference in their entireties.

### FIELD OF THE TECHNOLOGY

This application relates to the field of Internet technologies, and in particular, to a service processing method, a storage medium, and a terminal.

### BACKGROUND OF THE DISCLOSURE

With rapid development of Internet technologies, cards and vouchers are applied increasingly widely. Cards and vouchers include membership cards, stored value cards, vouchers, discount coupons, and the like. When a user performs consumption in a business, the user can enjoy a service corresponding to a card or voucher by showing the card or voucher. A membership card is used as an example. A membership card is a card held by a member, and is an identification card of the member. A membership system is a currently popular a service management mode, and can improve a customer retention rate and increase customer loyalty to an enterprise. An increasing quantity of enterprises use such a service mode. Membership cards of a large quantity of businesses, such as department stores, restaurants, and KTV lounges, can provide membership card services such as points and discounts. To stimulate consumption, businesses do not limit a card or voucher to be used by a cardholder only, the cardholder can lend the card or voucher to a relative and a friend for use, and a consumer who borrows the card or voucher can also enjoy a card or voucher service of the business by showing the card or voucher. A conventional a card or voucher sharing method is that a card or voucher holder lends a card or voucher to a sharer, and the sharer holds the card or voucher and shows the card or voucher during payment, to enjoy a price concession. However, such a sharing method requires the sharer to hold the card or voucher, but the card or voucher is unique, and when the sharer performs consumption, another person cannot use the card or voucher.

Therefore, if the conventional card or voucher sharing method is used, a utilization ratio of a card or voucher is low.

### SUMMARY

According to various embodiments provided by this application, a service processing method, a storage medium, and a terminal are provided.

According to a first aspect of the present disclosure, a service processing method is performed at a terminal having one or more processors and memory storing programs to be executed by the one or more processors, the method comprising:

obtaining, by the terminal, card or voucher information and a sharing initiator identifier when receiving a request for sharing a card or voucher from a user of a social network application;

obtaining, by the terminal, a list of associated users of the social network application, the list of associated users including each piece of user information having an association with the sharing initiator identifier and being friends of the user;

obtaining, by the terminal, a sharer identifier selected by using the list of associated users; and

sending, by the terminal, the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

According to a second aspect of the present disclosure, a non-transitory computer readable storage medium stores a plurality of machine readable instructions in connection with a terminal having one or more processors. The plurality of machine readable instructions, when executed by the one or more processors, cause the terminal to perform the aforementioned service processing method.

According to a second aspect of the present disclosure, a terminal has one or more processors, memory coupled to the one or more processors and a plurality of programs stored in the memory that, when executed by the one or more processors, cause the computing device to perform the aforementioned service processing method.

Details of one or more embodiments of this application are provided in the following accompanying drawings and descriptions. Other features, objectives, and advantages of this application become more obvious with reference to the specification, the accompanying drawings, and the claims.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a schematic diagram of an application environment of a service processing method according to an embodiment.

FIG. 2 is a schematic diagram of an internal structure of a terminal in an embodiment.

FIG. 3 is a flowchart of a service processing method according to an embodiment.

FIG. 4 is a schematic diagram of a list of associated users according to an embodiment.

FIG. 5 is a flowchart of a step of obtaining card or voucher information and a sharing initiator identifier according to an embodiment.

FIG. 6 is a schematic diagram of photographing, by a terminal, a physical card or voucher according to an embodiment.

FIG. 7 is a schematic diagram of a display interface of a card or voucher received by a sharer terminal in an embodiment.

FIG. 8 is a schematic diagram of a display interface of a card or voucher received by a sharer terminal in another embodiment.

FIG. 9 is a flowchart of a step of obtaining a list of associated users according to an embodiment.

FIG. 10 is a flowchart of a service processing method according to another embodiment.

FIG. 11 is a schematic diagram of a display interface of a social network application according to an embodiment.

FIG. 12 is a schematic diagram of a card or voucher display interface according to an embodiment.

FIG. 13 is a flowchart of a service processing method according to still another embodiment.

FIG. 14 is a schematic interaction diagram corresponding to a service processing method shown in FIG. 13.

FIG. 15 is a schematic diagram of a display interface of a resource transfer request confirmation according to an embodiment.

FIG. 16 is a schematic diagram of resource information according to an embodiment.

FIG. 17 is a flowchart of a service processing method according to another embodiment.

FIG. 18 is a flowchart of a service processing method according to another embodiment.

FIG. 19 is a schematic diagram of a transfer value message according to an embodiment.

FIG. 20 is a structural block diagram of a service processing apparatus according to an embodiment.

FIG. 21 is a structural block diagram of a service processing apparatus according to another embodiment.

FIG. 22 is a structural block diagram of a service processing apparatus according to still another embodiment.

FIG. 23 is a structural block diagram of a service processing apparatus according to yet another embodiment.

### DESCRIPTION OF EMBODIMENTS

To make the objectives, technical solutions, and advantages of this application clearer and more comprehensible, the following further describes this application in detail with reference to the accompanying drawings and embodiments. It should be understood that the specific implementations described herein are merely used to explain this application but are not intended to limit this application.

This application provides a service processing method, where a user can share a card or voucher with another user by performing an operation on a terminal.

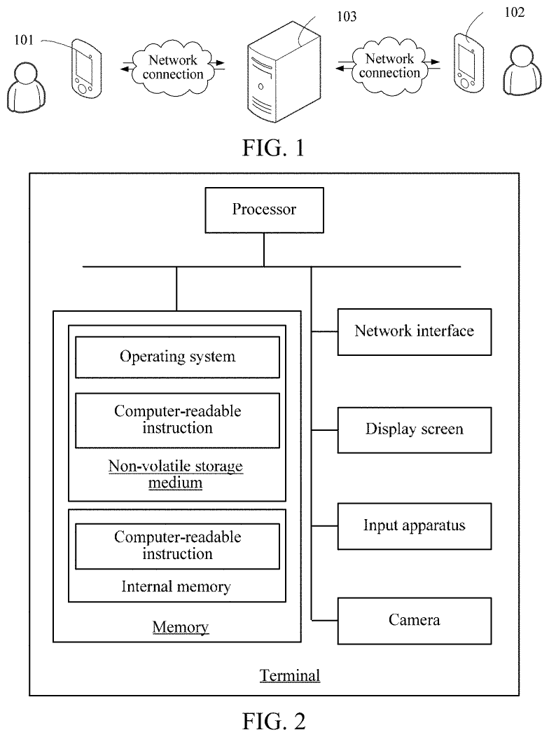

FIG. 1 is a schematic diagram of an application environment of a service processing method according to an embodiment. As shown in FIG. 1, the application environment includes a first terminal 101, a second terminal 102, and a server 103. The first terminal 101 and the second terminal 102 separately communicate with the server 103 through a network. The first terminal 101 is a sharing terminal, and the second terminal 102 is a receiving terminal. The first terminal 101 shares a card or voucher with the second terminal 102 through the server 103. When a user performs consumption, the user can enjoy a service corresponding to a card or voucher by presenting the card or voucher to a business through the second terminal 102. The first terminal 101 and the second terminal 102 may be intelligent mobile terminals, and include, but are not limited to, mobile phones, tablet computers, personal digital assistants, or wearable devices.

FIG. 2 is a schematic diagram of an internal structure of a terminal in an embodiment. The terminal may be specifically the first terminal or the second terminal shown in FIG. 1. As shown in FIG. 2, the terminal includes a processor, a memory, a network interface, a display screen, a camera, and an input apparatus that are connected through a system bus. The memory includes a non-volatile storage medium and an internal memory. The storage medium of the terminal stores an operating system and computer-readable instructions. When the computer-readable instructions are executed by the processor, a service processing method is implemented. The processor of the terminal is configured to provide computing and control capabilities, to support running of the entire terminal. The internal memory of the terminal may store computer-readable instructions. When executed by the processor, the computer-readable instructions may cause the processor to perform a service processing method. The network interface of the terminal is configured to perform network communication with a server, for example, send a card or voucher sharing request to the server and receive a card or voucher sent by the server. The camera of the terminal is configured to capture an image frame. The display screen of the terminal may be a liquid crystal display screen, an e-ink display screen, or the like. The input apparatus may be a touch layer covering the display screen, or may be a key, a track ball, or a touchpad disposed on a housing of the terminal, or may be an external keyboard, touchpad, or mouse. The terminal may be a mobile phone, a tablet computer, a personal digital assistant, a wearable device, or the like. A person skilled in the art may understand that, in the structure shown in FIG. 2A, only a block diagram of a partial structure related to a solution in this application is shown, and does not constitute a limit to the terminal to which the solution in this application is applied. Specifically, the terminal may include more components or fewer components than those shown in the figure, or some components may be combined, or a different component deployment may be used.

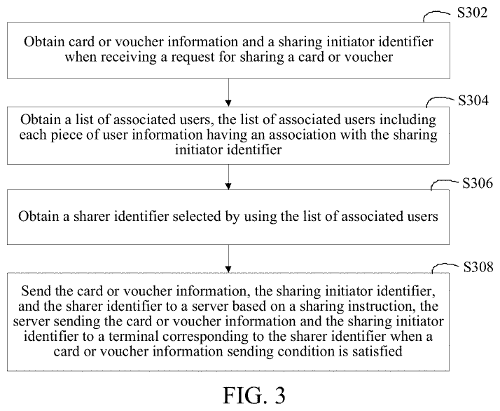

FIG. 3 is a flowchart of a service processing method according to an embodiment. The method runs the first terminal 101 shown in FIG. 1. As shown in FIG. 3, the method includes the following steps.

S302: Obtain card or voucher information and a sharing initiator identifier when receiving a request for sharing a card or voucher.

A card or voucher is issued by a business and is a certificate for a user to enjoy a corresponding service marked by the card or voucher. Cards and vouchers include membership cards, stored value cards, vouchers, discount coupons, and the like.

For example, a membership card is issued by a business and is an identification card of a member. During consumption, a membership service provided by a business can be enjoyed by showing a membership card. The membership service includes a privilege, such as a member price, a discount, or a price break discount, provided by the business for a member during consumption. Forms of a membership card may be a physical membership card and a virtual membership card. The virtual membership card is an electronic card or voucher issued by a business through a social network server. The card or voucher is stored in a terminal and has all functions, such as a discount and a point, of a physical membership card. The physical membership card may be stored in a terminal in a form of electronic data, for example, a picture of the physical membership card.

For another example, a stored value card is issued by a business, and may be a physical stored value card and a virtual stored value card. The virtual stored value card is an electronic card or voucher issued by a business through a social application server end to a topping-up user. The electronic card or voucher is stored in a terminal and has a payment function of a stored value card. After a cardholder tops up a specific amount of money to a business, the business issues a stored value card to the cardholder. The cardholder may share the stored value card with a friend through a social application. The physical stored value card may be stored in a terminal in a form of electronic data, for example, a picture of the physical stored value card. In this embodiment, the stored value card is a stored value card shared by another user through a social application.

A sharing request is generated based on a sharing operation performed by a user on a card or voucher on a terminal. For example, the user selects to-be-shared card or voucher by using the terminal and performs the sharing operation, to obtain the sharing request. Corresponding card or voucher information and a corresponding sharing initiator identifier are obtained based on the sharing request. The card or voucher information includes a card or voucher issuer (that is, a business) name, a card or voucher account, and/or a cardholder identifier. The sharing initiator identifier is a user identifier of an initiator of sharing on a social network, and a cardholder identifier is a user identifier of a card or voucher holder on the social network, and is usually a user identifier first initiating sharing of the card or voucher.

S304: Obtain a list of associated users, the list of associated users including each piece of user information having an association with the sharing initiator identifier and being friends of the user.

In a social network, identifiers of users who are friends of each other are associated with each other, and when a user joins a specific group, a user identifier and a group identifier are associated with each other. A list of associated users is obtained by obtaining each piece of user information having an association with a sharing initiator identifier. The list of associated users may include a friend and/or a group of a user.

S306: Obtain a sharer identifier selected by using the list of associated users.

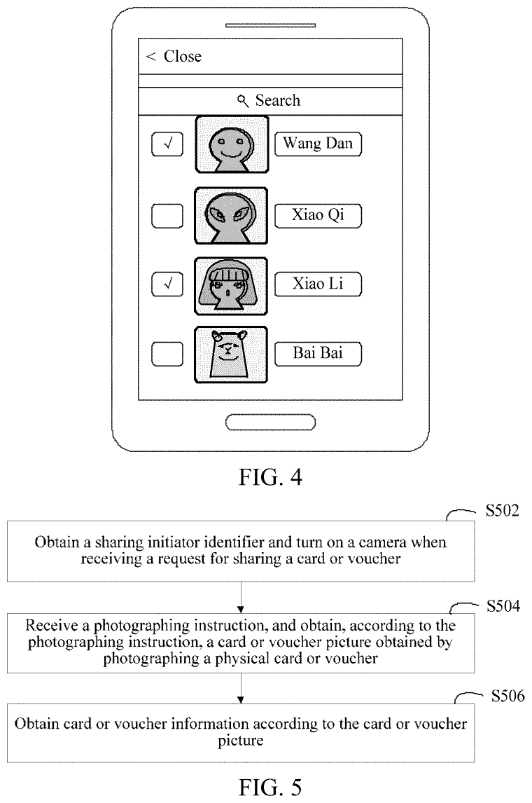

FIG. 4 is a schematic diagram of a list of associated users according to an embodiment. The list of associated users is presented on the terminal, and the user selects a friend and/or a group as sharers a sharer by performing an operation on the terminal, to obtain a selected sharer identifier.

S308: Send the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

The card or voucher information sending condition may be set by the server. For example, the server sends the received card or voucher information and sharing initiator identifier to a terminal of one of the associated users corresponding to the sharer identifier in real time. For another example, when receiving the card or voucher information, the server sends a status update notification to the terminal of one of the associated users corresponding to the sharer identifier. The terminal of one of the associated users corresponding to the sharer identifier displays a status update flag or a message notification according to the status update notification, to prompt the user that new card or voucher sharing is received. A sharer receives the card or voucher information and the sharing initiator identifier by sending, on the terminal, a data request to the server. Specifically, the sharer sends the data request to the server by refreshing an interface of a received card or voucher on the terminal.

The card or voucher information and sharing initiator identifier are stored in the terminal of one of the associated users corresponding to the sharer. During consumption, the sharer obtains a card or voucher service by presenting the card or voucher information by using the terminal. It may be understood that the user may also share the received card or voucher with another friend by using the service processing method of this embodiment.

In the foregoing service processing method, card or voucher information and a sharing initiator identifier are obtained when a request for sharing a card or voucher is received; a list of associated users is obtained, the list of associated users including each piece of user information having an association with the sharing initiator identifier and being friends of the user; a sharer identifier selected by using the list of associated users is obtained; and the card or voucher information, the sharing initiator identifier, and the sharer identifier are sent to a server based on a sharing instruction, the server sending the card or voucher information and the sharing initiator identifier to the terminal of one of the associated users corresponding to the sharer identifier when a card or voucher information sending condition is satisfied. Because the card or voucher information can be shared with another user associated with sharing initiator identifier, the card or voucher information no longer relies on a physical card or voucher, the another user can also have card or voucher information and performs consumption based on the card or voucher information, so that a utilization ratio of a card or voucher is improved.

In another embodiment, a card or voucher is a physical card or voucher, and card or voucher information is stored in the terminal in a form of electronic data by photographing the physical card or voucher. Specifically, as shown in FIG. 5, the step of obtaining card or voucher information and a sharing initiator identifier includes:

S502: Obtain a sharing initiator identifier and turn on a camera when receiving a request for sharing a card or voucher.

A camera driver is installed on the terminal. When receiving the request for sharing a card or voucher, the terminal obtains the sharing initiator identifier and executes the driver to turning on the camera of the terminal. After the camera is turned on, image information within an angular field of view is captured.

S504: Receive a photographing instruction, and obtain, according to the photographing instruction, a card or voucher picture obtained by photographing a physical card or voucher.

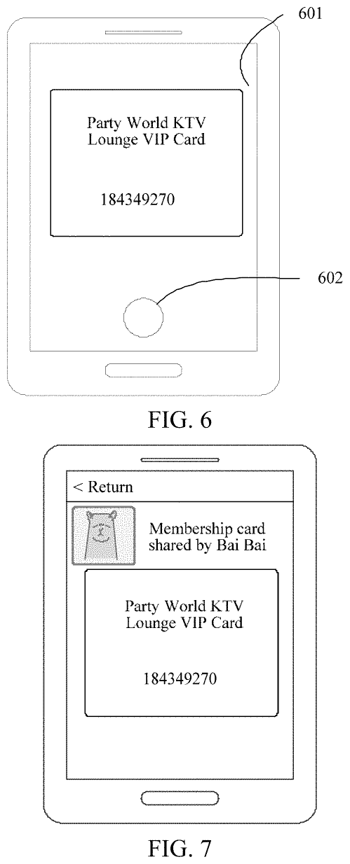

FIG. 6 is a schematic diagram of photographing, by a terminal, a physical card or voucher according to an embodiment. As shown in FIG. 6, after the camera is turned on, a display area 601 of a display interface of the terminal displays image information of a visual range of the camera. The display interface of the terminal further displays a camera bottom 602. The user places the physical card or voucher inside the visual range of the camera, and clicks the camera bottom 602 to trigger a photographing instruction. The terminal receives the photographing instruction, and photographs the physical card or voucher according to the photographing instruction to obtain a card or voucher picture. After the photographing is completed, the card or voucher picture is stored in the terminal.

S506: Obtain the card or voucher information according to the card or voucher picture.

In an embodiment, card or voucher information sent by a sharing terminal to the server may include only a card or voucher picture. During consumption, a sharer user can enjoy a card or voucher service by showing the card or voucher picture to the business.

In another embodiment, card or voucher information sent by a sharing terminal to the server may include only a card or voucher issuer name and a card or voucher account. Specifically, the step of obtaining card or voucher information according to a card or voucher picture includes: identifying text on the card or voucher picture to obtain a card or voucher issuer name and a card or voucher account, the card or voucher information including the card or voucher issuer name and the card or voucher account.

Usually, an issuer (a business) name and a card or voucher account are printed on a physical card or voucher, and text on the card or voucher picture is identified by using a text recognition technology, to obtain the card or voucher issuer name and the card or voucher account. The card or voucher information sent by the sharing terminal to the server may include only the card or voucher issuer name and the card or voucher account. During consumption the sharer user shows the card or voucher account, and after the business performs a check according to card or voucher account, the sharer may enjoy a card or voucher service. In another implementation, the card or voucher information sent by the sharing terminal to the server includes a card or voucher picture, an issuer name, and a card or voucher account. In an embodiment, a display interface of a card or voucher received by the sharing terminal is shown in FIG. 7.

In yet another embodiment, the card or voucher information sent by the sharing terminal to the server may be a barcode or two-dimensional barcode including a card or voucher issuer name and of a card or voucher account. Specifically, the step of obtaining card or voucher information according to a card or voucher picture includes: generating a corresponding barcode or two-dimensional barcode according to the card or voucher issuer name and the card or voucher account, the card or voucher information including the barcode or the two-dimensional barcode.

Usually, an issuer (a business) name and a card or voucher account are printed on a physical card or voucher, and text on the card or voucher picture is identified by using a text recognition technology, to obtain the card or voucher issuer name and the card or voucher account. According to the identified card or voucher issuer name and card or voucher account, a barcode is generated by using a barcode generator, or a two-dimensional barcode is generated by using a two-dimensional barcode generator. The card or voucher information sent by the sharing terminal to the server may be the barcode or the two-dimensional barcode including the card or voucher issuer name and the card or voucher account. When the sharing terminal performs consumption, the business scans the barcode or the two-dimensional barcode with a barcode scanning gun of a cashier terminal, to check membership information, and after the membership information is checked, the sharer can enjoy a card or voucher service. In an embodiment, a display interface of a card or voucher received by the sharing terminal is shown in FIG. 8.

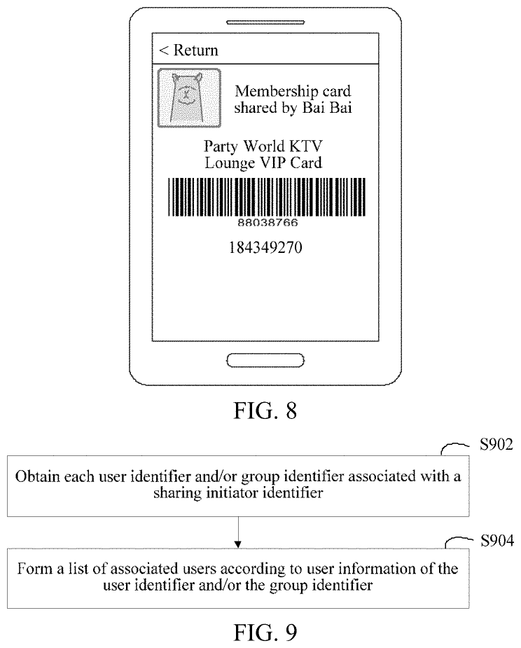

In an embodiment, as shown in FIG. 9, the step of obtaining a list of associated users includes the following steps.

S902: Obtain each user identifier and/or group identifier associated with the sharing initiator identifier.

In a social network, identifiers of users who are friends of each other are associated with each other, and when a user joins a specific group, a user identifier and a group identifier are associated with each other. Each user identifier and/or group identifier associated with the sharing initiator identifier are or is obtained.

S904: Form the list of associated users according to user information of the user identifier and/or the group identifier.

Specifically, after each user identifier and/or group identifier associated with the sharing initiator identifier are or is obtained, the obtained user identifier and/or the group identifier are or is ranked to obtain a list of associated users. Specifically, a first user identifier and/or a first group identifier interacting with the sharing initiator identifier within a specified recent time period, for example, within the last month, are or is obtained, the first user identifier and/or the first group identifier are or is ranked according to a last interaction time. A second user identifier and/or a second group identifier in one or more associated user identifiers and/or group identifiers other than the first user identifier and/or the first group identifier is ranked alphabetically according to an initial letter to obtain the list of associated users. The first user identifier and/or the first group identifier interacting the sharing initiator identifier within the specified recent time period are recent contacts or is a recent contact of the sharing initiator identifier. It may be considered that the recent contact has a relatively close relationship with a sharing initiator to a large extent, and there is a large probability that the sharing initiator selects a user from the one or more recent contacts to share with the user. Therefore, ranking the recent contact higher makes it easy for the user to make a selection.

In another embodiment, a first user identifier and/or a first group identifier interacting with the sharing initiator identifier within a specified recent time period are or is obtained, the first user identifier and/or the first group identifier are or is ranked according to a recent interaction frequency. A second user identifier and/or a second group identifier in one or more associated user identifiers and/or group identifiers other than the first user identifier and/or the first group identifier is ranked alphabetically according to an initial letter to obtain the list of associated users. The first user identifier and/or the first group identifier interacting the sharing initiator identifier within the specified recent time period are recent contacts or is a recent contact of the sharing initiator identifier. It may be considered that the recent contact has a relatively close relationship with a sharing initiator to a large extent, and there is a large probability that the sharing initiator selects a user from the one or more recent contacts to share with the user. Therefore, ranking the first user identifier and/or the first group identifier according to the recent interaction frequency makes it easy for the user to make a selection.

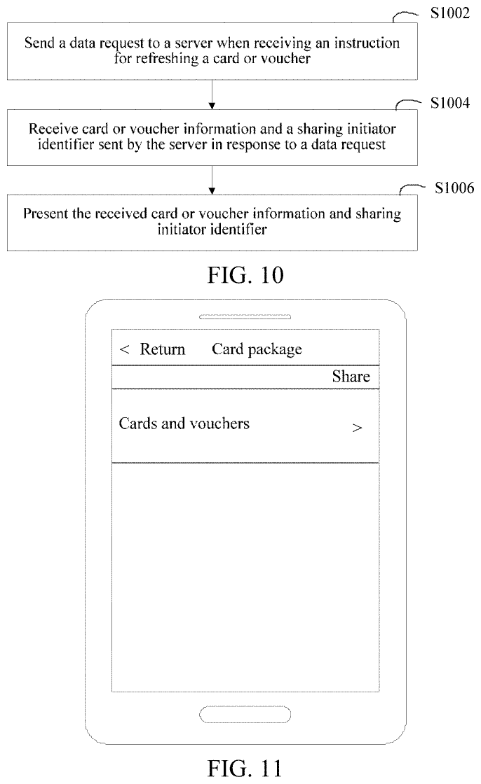

It may be understood that in a social network, a sharing initiator may alternatively be a sharer, and receive a card or voucher shared by another user terminal. As shown in FIG. 10, the service processing method further includes the following steps.

S1002: Send a data request to the server when receiving an instruction for refreshing a card or voucher.

When receiving the card or voucher information, the server sends a status update notification to the terminal of one of the associated users corresponding to the sharer identifier. The terminal of one of the associated users corresponding to the sharer identifier displays a status update flag or a message notification according to the status update notification, to prompt the user that new card or voucher sharing is received. A sharer receives the card or voucher information and the sharing initiator identifier by sending, on the terminal, a data request to the server. Specifically, the sharer sends the data request to the server by refreshing an interface of a received card or voucher on the terminal.

S1004: Receive card or voucher information and a sharing initiator identifier sent by the server in response to the data request.

The server sends the card or voucher information and the sharing initiator identifier to a sharer terminal according to the data request. The card or voucher information may be any one of the following cases: a card or voucher picture, a card or voucher issuer and a card or voucher account, and a barcode or two-dimensional barcode including information about a card or voucher issuer and a card or voucher account.

S1006: Present the received card or voucher information and sharing initiator identifier.

The received card or voucher information and sharing initiator identifier are presented on the sharer terminal. A schematic diagram of a display interface of the received card or voucher information and sharing initiator identifier according to an embodiment is shown in FIG. 7, and a schematic diagram of a display interface of the received card or voucher information and sharing initiator identifier according to another embodiment is shown in FIG. 8.

The card or voucher service processing method of this application is described below with reference to specific embodiments.

A schematic diagram of a display interface of a social network application according to an embodiment is shown in FIG. 11. A user may initiate card or voucher sharing based on the social network application. As shown in FIG. 11, the social network application is provided with a card package, used to store a card or voucher of the user. In this embodiment, the card or voucher may be a physical card or voucher and a virtual card or voucher.

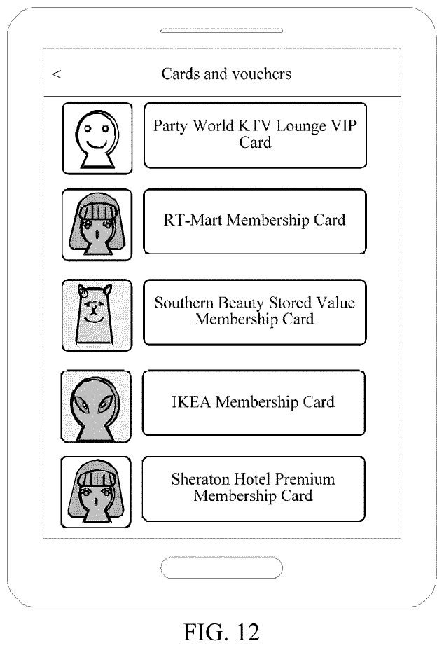

In this embodiment, the stored physical card or voucher and virtual card or voucher may be shared. Specifically, in the display interface shown in FIG. 11, Cards and vouchers are clicked, to display all cards and vouchers of the user as shown in FIG. 12. For a card or voucher shown in FIG. 12, a sharing operation is triggered by a long press, to obtain card or voucher information.

In this embodiment, alternatively, physical card or voucher information of a sharing initiator may be collected, and the physical card or voucher is shared. Specifically, in the display interface shown in FIG. 11, the physical card or voucher is photographed by clicking a “Share” button to obtain the physical card or voucher information. FIG. 6 is a schematic diagram of photographing, by a terminal, a physical card or voucher according to an embodiment. As shown in FIG. 6, after the camera is turned on, a display area 601 of a display interface of the terminal displays image information of a visual range of the camera. The display interface of the terminal further displays a camera bottom 602. The user places the physical card or voucher inside the visual range of the camera, and clicks the camera bottom 602 to send a photographing instruction. The terminal receives the photographing instruction, and photographs the physical card or voucher according to the photographing instruction to obtain a card or voucher picture. After the photographing is completed, the card or voucher picture is stored in the terminal.

After the sharing operation is triggered to obtain the card or voucher information and sharing initiator identifier, the list of associated users shown in FIG. 4 is obtained. The list of associated users includes each piece of user information having an association with the sharing initiator identifier. The user obtains a sharer selected by using the list of one or more associated and obtains a selected sharer identifier. The card or voucher information, the sharing initiator identifier, and the sharer identifier are sent to the server based on the sharing instruction.

When receiving the card or voucher information, the server sends a status update notification to the terminal of one of the associated users corresponding to the sharer identifier. The terminal of one of the associated users corresponding to the sharer identifier displays a status update flag or a message notification according to the status update notification, to prompt the user that new card or voucher sharing is received. A sharer receives the card or voucher information and the sharing initiator identifier by sending, on the terminal, a data request to the server. A display interface of a card or voucher received by the sharing initiator is shown in FIG. 7 or FIG. 8.

According to another aspect, the card or voucher further includes a stored value card. The stored value card is also referred to as a pre-paid card. To increase funds withdrawn in advance and lock high-end customers, an increasing quantity of businesses launch stored value cards. A stored value card is issued by a business, and by pre-paying (topping-up) a specific amount of money to the business, a cardholder can store the money in a card, and has the money deducted from the card during consumption.

Usually, a relatively large amount of money is required to be stored in a stored value card. To reduce a risk of a cardholder and stimulate consumption, businesses do not limit a stored value card to be used by the cardholder only, the cardholder can lend the stored value card to a relative and a friend for use, and a consumer who borrows the stored value card can also perform consumption in the business by showing the stored value card.

However, the stored value card is unique, when the consumer who borrows the stored value card performs consumption, the cardholder or another relative or friend of the cardholder cannot use the stored value card. Consequently, a utilization ratio of the stored value card is low. Using the foregoing service processing method can improve a utilization ratio of the stored value card.

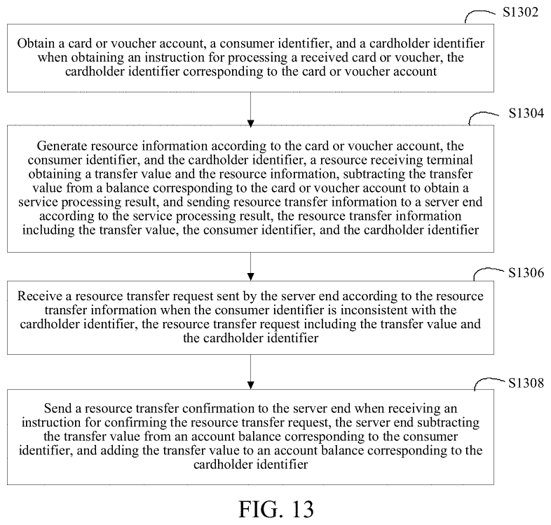

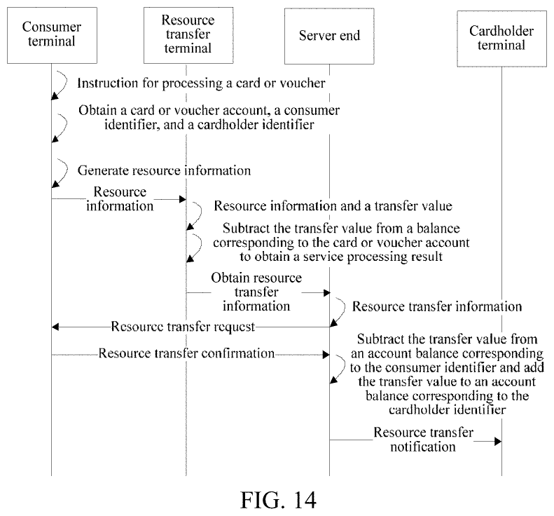

Specifically, when consumption is performed based on a shared stored value card, as shown in FIG. 13 and FIG. 14, a service processing method includes the following steps:

S1302: Obtain a card or voucher account, a consumer identifier, and a cardholder identifier when obtaining an instruction for processing a received card or voucher, the cardholder identifier corresponding to the card or voucher account.

In this embodiment, the card or voucher is a stored value card. The stored value card is issued by a business, and may be a physical stored value card and a virtual stored value card. The virtual stored value card is an electronic card or voucher issued by a business through a social application server end to a topping-up user. The electronic card or voucher is stored in a terminal and has a payment function of a stored value card. After a cardholder tops up a specific amount of money to a business, the business issues a stored value card to the cardholder. The cardholder may share the stored value card with a friend through a social application. The physical stored value card may be stored in a terminal in a form of electronic data, for example, a picture of the physical stored value card. In this embodiment, the stored value card is a stored value card shared by another user through a social application.

A processing instruction is generated based on a payment operation performed by a user on a card or voucher on a terminal. For example, the user selects a to-be-used card or voucher on the terminal and performs a payment operation, and the terminal generates a processing instruction according to the payment operation. A card or voucher account, a consumer identifier, and a cardholder identifier are obtained based on the processing instruction, the cardholder identifier corresponding to the card or voucher account. The cardholder identifier is an identifier of a holder of a card or voucher, for example, an account of the cardholder on a social application.

S1304: Generate resource information according to the card or voucher account, the consumer identifier, and the cardholder identifier, a resource receiving terminal obtaining a transfer value and the resource information, subtracting the transfer value from a balance corresponding to the card or voucher account to obtain a service processing result, and sending resource transfer information to a server end according to the service processing result, the resource transfer information including the transfer value, the consumer identifier, and the cardholder identifier.

The resource information may include data including the card or voucher account, the consumer identifier, and the cardholder identifier, and the data is sent to the resource receiving terminal through point-to-point communication between a first terminal and the resource receiving terminal. The resource information may alternatively be a barcode and/or two-dimensional barcode including the card or voucher account, the consumer identified, and the cardholder identifier. The resource receiving terminal scans, by using a scanning gun, the barcode and/or two-dimensional barcode displayed on the first terminal, to read and obtain the resource information.

In this embodiment, the resource receiving terminal may be a cashier terminal on a business side. After performing consumption in the business, the consumer initiates payment by using a card or voucher in a form of electronic data. The resource receiving terminal is enabled by presenting a two-dimensional barcode or in a point-to-point communication manner to obtain resource information. The resource receiving terminal further obtains a transfer value. The transfer value is an actual consumption amount or a consumption amount after concession of a consumer in a business.

A cardholder obtains a card or voucher by topping up a specific amount of money in the business. When obtaining the resource information and the transfer value, the resource receiving terminal on the business side reduces a balance corresponding to a card or voucher account by the transfer value to obtain a service processing result. The service processing result includes a balance of the card or voucher account after consumption.

The resource receiving terminal sends resource transfer information to a server end according to the service processing result. The server end in this embodiment is a server end of a social application. The resource transfer information includes the transfer value, the consumer identifier, and the cardholder identifier.

S1306: Receive a resource transfer request sent by the server end according to the resource transfer information when the consumer identifier is inconsistent with the cardholder identifier, the resource transfer request including the transfer value and the cardholder identifier.

When receiving the resource transfer information, the server end determines whether the consumer identifier is consistent with the cardholder identifier. If the consumer identifier is consistent with the cardholder identifier, indicating that the consumer is the cardholder, a resource transfer does not need to be performed. If the consumer identifier is inconsistent with the cardholder identifier, the server end sends a resource transfer request to a corresponding terminal (that is, the first terminal) according to the resource transfer information, the resource transfer request including the transfer value and the cardholder identifier.

S1308: Send a resource transfer confirmation to the server end when receiving an instruction for confirming the resource transfer request, the server end subtracting the transfer value from an account balance corresponding to the consumer identifier, and adding the transfer value to an account balance corresponding to the cardholder identifier.

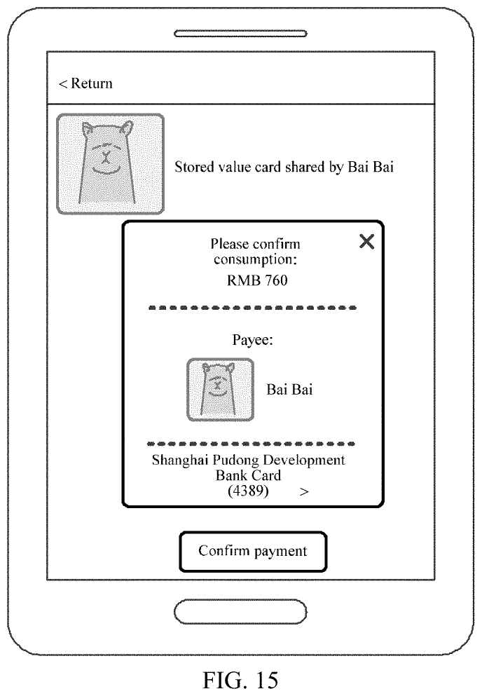

The first terminal presents a display interface of the resource transfer confirmation according to the resource transfer request. A diagram of a display interface of a resource transfer request confirmation according to an embodiment is shown in FIG. 15. A transfer value (a consumption amount), a cardholder identifier (a transfer object identifier), and a payment mode. A payment mode supported by a social application may be selected as the payment mode, for example, a bank card bound to the social application or small money of the user on the social application. The payment mode may be selected by the user.

The consumer clicks “Confirm” on the display interface shown in FIG. 15, and when receiving the instruction for confirming the resource transfer request, the first terminal sends the resource transfer confirmation to the server end. The server end subtracts the transfer value from an account balance corresponding to the consumer identifier, and adds the transfer value to an account balance corresponding to the cardholder identifier.

In the foregoing service processing method, because after subtracting, according to the resource information, the transfer value from the balance corresponding to the card or voucher account, the resource receiving terminal adds the transfer value to the account balance corresponding to the cardholder identifier, the card or voucher information no longer relies on a physical card or voucher, and another user can also have the card or voucher information, perform consumption based on the card or voucher information, and after consumption, make payment to the cardholder of the card or voucher, thereby improving a utilization ratio of the card or voucher. Improvement of the utilization ratio of the card or voucher further accelerates consumption of a balance in the card or voucher and reduces a fund risk of the cardholder.

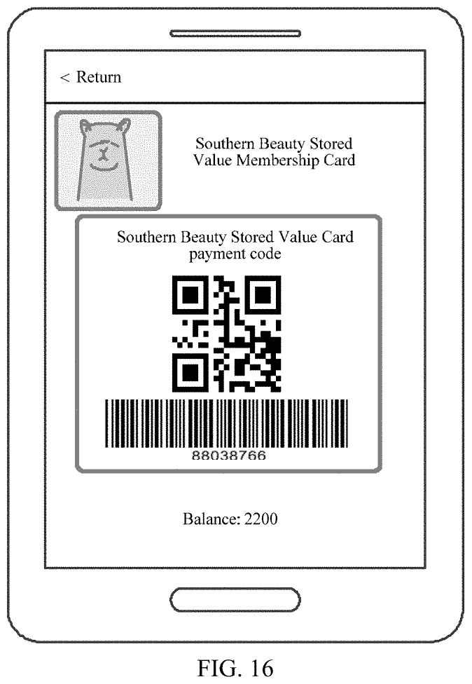

In an embodiment, the step of generating resource information according to the card or voucher account, the consumer identifier, and the cardholder identifier includes generating a two-dimensional barcode and/or a barcode according to the card or voucher account, the consumer identifier, and the cardholder identifier, the resource information including the two-dimensional barcode and/or the barcode. In this embodiment, the two-dimensional barcode and/or the barcode are or is generated according to the card or voucher account, the consumer identifier, and the cardholder identifier. Two-dimensional barcode and/or barcode are or are payment codes or is a payment code. The consumer presents the payment code by using the terminal. The resource receiving terminal obtains the resource information including the card or voucher account, the consumer identifier, and the cardholder identifier by scanning, by using a barcode scanning gun, the barcode or and/or two-dimensional barcode displayed on the first terminal. Resource information according to an embodiment is shown in FIG. 16.

In another embodiment, after the step of generating resource information according to the card or voucher account, the consumer identifier, and the cardholder identifier, the method further includes communicating with the resource receiving terminal to send the resource information to the resource receiving terminal.

In this embodiment, a communication mode between the resource receiving terminal and the first terminal is point-to-point communication. Specifically, by using the Near Field Communication (NFC) technology, the Bluetooth technology, the infrared technology, the ZigBee technology, the Ultra WideBand (UWB) technology, or the radio frequency identification (RFID) technology, the first terminal sends the resource information including the card or voucher account, the consumer identifier, and the cardholder identifier to the resource receiving terminal. It may be understood that the resource receiving terminal and the first terminal include corresponding hardware devices and software devices, and can be in a communication connection based on the NFC, Bluetooth, infrared, ZigBee, UWB, or RFID.

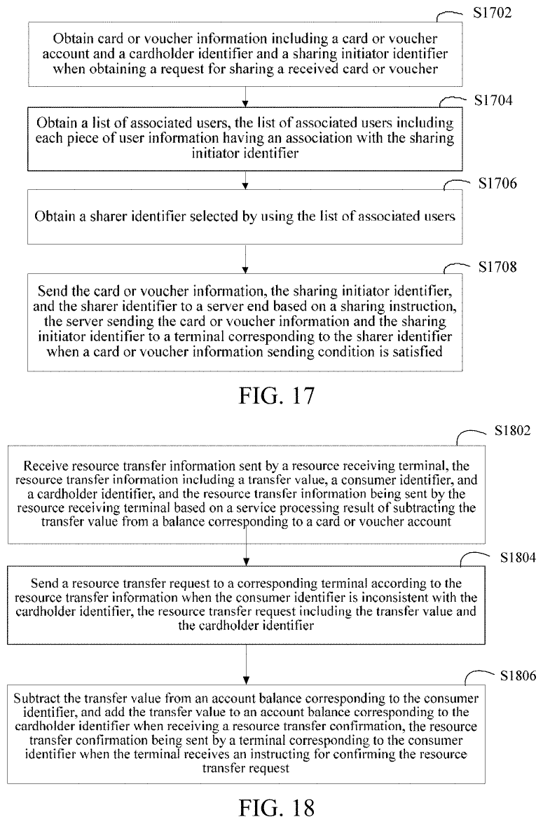

In another embodiment, the first terminal may alternatively serve as a sharing terminal, and share a received card or voucher with another friend on a social application. Specifically, as shown in FIG. 17, the method includes the following steps.

S1702: Obtain card or voucher information including a card or voucher account and a cardholder identifier and a sharing initiator identifier when obtaining a request for sharing a received card or voucher.

In this embodiment, the card or voucher is a card or voucher received by the sharing initiator and shared by a friend on the social application. The sharing request is generated based on a sharing operation performed by the sharing initiator on the card or voucher on the first terminal. For example, the user selects to-be-shared card or voucher by using the first terminal and performs the sharing operation, to obtain the sharing request. Card or voucher information, a cardholder identifier, and a sharing initiator identifier, are obtained based on the sharing request. The cardholder identifier is an initiator of first sharing of the card or voucher.

S1704: Obtain a list of associated users, the list of associated users including each piece of user information having an association with the sharing initiator identifier and being friends of the user.

In a social application, identifiers of users who are friends of each other are associated with each other, and when a user joins a specific group, a user identifier and a group identifier are associated with each other. A list of associated users is obtained by obtaining each piece of user information having an association with a sharing initiator identifier. The list of associated users may include a friend and/or a group of a user.

Specifically, after each user identifier and/or group identifier associated with the sharing initiator identifier are or is obtained, the obtained user identifier and/or the group identifier are or is ranked to obtain a list of associated users. Specifically, a first user identifier and/or a first group identifier interacting with the sharing initiator identifier within a specified recent time period, for example, within the last month, are or is obtained, the first user identifier and/or the first group identifier are or is ranked according to a last interaction time. A second user identifier and/or a second group identifier in one or more associated user identifiers and/or group identifiers other than the first user identifier and/or the first group identifier is ranked alphabetically according to an initial letter to obtain the list of associated users. The first user identifier and/or the first group identifier interacting the sharing initiator identifier within the specified recent time period are recent contacts or is a recent contact of the sharing initiator identifier. It may be considered that the recent contact has a relatively close relationship with the sharing initiator to a large extent, and there is a large probability that the sharing initiator selects a user from the one or more recent contacts to share with the user. Therefore, ranking the recent contact higher makes it easy for the user to make a selection.

S1706: Obtain a sharer identifier selected by using the list of associated users.

FIG. 4 is a schematic diagram of a list of associated users according to an embodiment. The list of associated users is presented on the terminal, and the user selects a friend and/or a group as sharers a sharer by performing an operation on the terminal, to obtain a selected sharer identifier.

S1708: Send the card or voucher information, the sharing initiator identifier, and the sharer identifier to a server end based on a sharing instruction, the server sending the card or voucher information and the sharing initiator identifier to a terminal of one of the associated users corresponding to the sharer identifier when a card or voucher information sending condition is satisfied.

The card or voucher information and sharing initiator identifier are stored in the terminal of one of the associated users corresponding to the sharer. The sharing initiator may perform, on the terminal, processing on the received card or voucher to implement payment.

In the foregoing service processing method, the first terminal may alternatively be a sharing terminal and share the received card or voucher with another user associated with the sharing initiator identifier, thereby increasing sharing objects and improving a utilization ratio of the card or voucher.

In an embodiment, a service processing method is provided, running on the server end 103 shown in FIG. 1. As shown in FIG. 18, the method includes the following steps.

S1802. Receive resource transfer information sent by a resource receiving terminal, the resource transfer information including a transfer value, a consumer identifier, and a cardholder identifier, and the resource transfer information being sent by the resource receiving terminal based on a service processing result of subtracting the transfer value from a balance corresponding to a card or voucher account.

When obtain an instruction for processing a card or voucher, the first terminal obtains a card or voucher account, a consumer identifier, and a cardholder identifier, and generates resource information according to the card or voucher account, the consumer identifier, and the cardholder identifier. The resource receiving terminal obtains a transfer value and the resource information, subtracts the transfer value from the balance corresponding to the card or voucher account to obtain the service processing result, and sends the resource transfer information to the server end according to the service processing result.

In this embodiment, the resource receiving terminal may be a cashier terminal on a business side. After performing consumption in the business, the consumer initiates payment by using a card or voucher in a form of electronic data. The resource receiving terminal is enabled by presenting a two-dimensional barcode or in a point-to-point communication manner to obtain resource information. The resource receiving terminal further obtains a transfer value. The transfer value is an actual consumption amount or a consumption amount after concession of a consumer in a business.

A cardholder obtains a card or voucher by topping up a specific amount of money in the business. When obtaining the resource information and the transfer value, the resource receiving terminal on the business side reduces a balance corresponding to a card or voucher account by the transfer value to obtain a service processing result. The service processing result includes a balance of the card or voucher account after consumption.

The resource receiving terminal sends resource transfer information to a server end according to the service processing result. The server end in this embodiment is a server end of a social application. The resource transfer information includes the transfer value, the consumer identifier, and the cardholder identifier.

S1804: Send a resource transfer request to a corresponding terminal according to the resource transfer information when the consumer identifier is inconsistent with the cardholder identifier, the resource transfer request including the transfer value and the cardholder identifier.

When receiving the resource transfer information, the server end determines whether the consumer identifier is consistent with the cardholder identifier. If the consumer identifier is consistent with the cardholder identifier, indicating that the consumer is the cardholder, a resource transfer does not need to be performed. If the consumer identifier is inconsistent with the cardholder identifier, the server end sends a resource transfer request to a corresponding terminal (that is, the first terminal) according to the resource transfer information, the resource transfer request including the transfer value and the cardholder identifier.

S1806: Subtract the transfer value from an account balance corresponding to the consumer identifier, and add the transfer value to an account balance corresponding to the cardholder identifier when receiving a resource transfer confirmation, the resource transfer confirmation being sent by a terminal of one of the associated users corresponding to the consumer identifier when the terminal receives an instructing for confirming the resource transfer request.

The first terminal presents a display interface of the resource transfer confirmation according to the resource transfer request. A diagram of a display interface of a resource transfer request confirmation according to an embodiment is shown in FIG. 15. A transfer value (a consumption amount), a cardholder identifier (a transfer object identifier), and a payment mode. A payment mode supported by a social application may be selected as the payment mode, for example, a bank card bound to the social application or small money of the user on the social application. The payment mode may be selected by the user.

The consumer clicks “Confirm” on the display interface shown in FIG. 15, and when receiving the instruction for confirming the resource transfer request, the first terminal sends the resource transfer confirmation to the server end. The server end subtracts the transfer value from an account balance corresponding to the consumer identifier, and adds the transfer value to an account balance corresponding to the cardholder identifier.

In the foregoing service processing method, because after subtracting, according to the resource information, the transfer value from the balance corresponding to the card or voucher account, the resource receiving terminal adds the transfer value to the account balance corresponding to the cardholder identifier, the card or voucher information no longer relies on a physical card or voucher, and another user can also have the card or voucher information, perform consumption based on the card or voucher information, and after consumption, make payment to the cardholder of the card or voucher, thereby improving a utilization ratio of the card or voucher.

In another embodiment, after the step of subtracting the transfer value from an account balance corresponding to the consumer identifier, and adding the transfer value to an account balance corresponding to the cardholder identifier when receiving a resource transfer confirmation, the method further includes: sending a transfer value message to a terminal of one of the associated users corresponding to the cardholder identifier, the transfer value message including the transfer value and the card or voucher account.

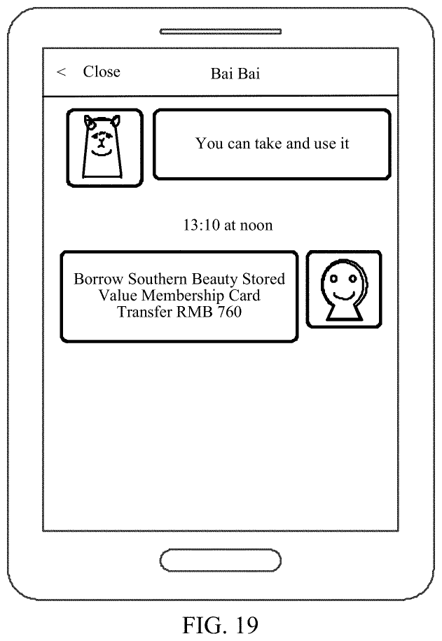

A transfer value message according to an embodiment is shown in FIG. 19. A data transfer message may include a use abstract and indicate a transfer reason and a balance.

In another embodiment, after the step of subtracting the transfer value from an account balance corresponding to the consumer identifier, and adding the transfer value to an account balance corresponding to the cardholder identifier when receiving a resource transfer confirmation, the method further includes: sending an updated account balance to a terminal of one of the associated users corresponding to the card or voucher account. It may be understood that after a cardholder shares a card or voucher with a friend on a social application, or a sharing initiator shares a card or voucher with a friend on a social application, a correspondence between a card or voucher account and a sharer identifier is established. After each time of consumption, an updated balance is sent to the terminal of one of the associated users corresponding to the card or voucher account.

The service processing method of the present disclosure is described below with reference to specific embodiments.

FIG. 12 is a schematic diagram of a card or voucher interface of a social network application according to an embodiment. As shown in FIG. 12, a consumer opens the card or voucher interface on the social application through a consumer terminal. A user selects a to-be-used card or voucher on the terminal and performs a payment operation, and the terminal generates a processing instruction according to the payment operation.

As shown in FIG. 14, the consumer terminal obtains a card or voucher account, a consumer identifier, and a cardholder identifier, the cardholder identifier corresponding to the card or voucher account. In this embodiment, the two-dimensional barcode and/or the barcode are or is generated according to the card or voucher account, the consumer identifier, and the cardholder identifier. Two-dimensional barcode and/or barcode are or are payment codes or is a payment code. The consumer presents the payment code by using the terminal. The resource receiving terminal obtains the resource information including the card or voucher account, the consumer identifier, and the cardholder identifier by scanning, by using a barcode scanning gun, the barcode or and/or two-dimensional barcode (which is the payment code) displayed on the consumer terminal. Resource information according to an embodiment is shown in FIG. 16.

When obtaining the resource information and the transfer value, the resource receiving terminal on the business side reduces a balance corresponding to a card or voucher account by the transfer value to obtain a service processing result. The service processing result includes a balance of the card or voucher account after consumption. The resource receiving terminal sends resource transfer information to a server end of the social application according to the service processing result.

When receiving the resource transfer information, the server end determines whether the consumer identifier is consistent with the cardholder identifier. If the consumer identifier is consistent with the cardholder identifier, indicating that the consumer is the cardholder, a resource transfer does not need to be performed. If the consumer identifier is inconsistent with the cardholder identifier, the server end sends a resource transfer request to a corresponding terminal (that is, the consumer terminal) according to the resource transfer information, the resource transfer request including the transfer value and the cardholder identifier.

The consumer terminal presents a display interface of the resource transfer confirmation according to the resource transfer request. A diagram of a display interface of a resource transfer request confirmation according to an embodiment is shown in FIG. 15. A transfer value (a consumption amount), a cardholder identifier (a transfer object identifier), and a payment mode. A payment mode supported by a social application may be selected as the payment mode, for example, a bank card bound to the social application or small money of the user on the social application. The payment mode may be selected by the user.

The consumer clicks “Confirm” on the display interface shown in FIG. 15, and when receiving the instruction for confirming the resource transfer request, the consumer terminal sends the resource transfer confirmation to the server end. The server end subtracts the transfer value from an account balance corresponding to the consumer identifier, and adds the transfer value to an account balance corresponding to the cardholder identifier.

The server end sends a transfer value message to a terminal of one of the associated users corresponding to the cardholder identifier, the transfer value message including transfer value and the card or voucher account. A transfer value message according to an embodiment is shown in FIG. 19. A data transfer message may include a use abstract and indicate a transfer reason.

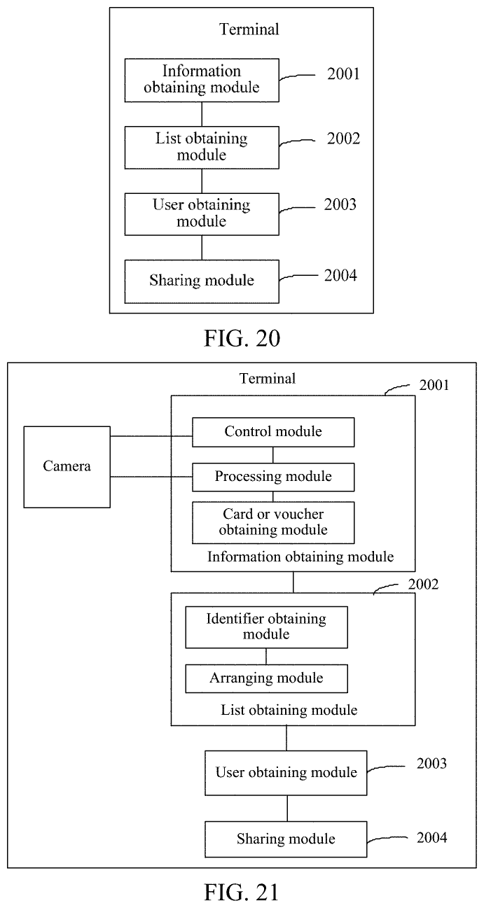

FIG. 20 is a structural block diagram of a terminal according to an embodiment. For an internal structure of the terminal, refer to the structure as shown in FIG. 2. Each module below may be implemented entirely or partially through software, hardware, or a combination thereof. As shown in FIG. 20, a service processing apparatus includes: an information obtaining module 2001, a list obtaining module 2002, a user obtaining module 2003, and a sharing module 2004.

The information obtaining module 2001 is configured to obtain, by a terminal, card or voucher information and a sharing initiator identifier when receiving a request for sharing a card or voucher.

The list obtaining module 2002 is configured to obtain a list of associated users, the list of associated users including each piece of user information having an association with the sharing initiator identifier and being friends of the user.

The user obtaining module 2003 is configured to obtain a sharer identifier selected by using the list of associated users.

The sharing module 2004 is configured to send the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

In another embodiment, as shown in FIG. 21, the information obtaining module 2001 includes a control module, a processing module, and a card or voucher obtaining module.

The control module is configured to obtain a sharing initiator identifier and turn on a camera when receiving a request for sharing a card or voucher.

The processing module is configured to receive a photographing instruction, and obtain, according to the photographing instruction, a card or voucher picture obtained by photographing a physical card or voucher.

The card or voucher obtaining module is configured to obtain card or voucher information according to the card or voucher picture.

Specifically, the card or voucher obtaining module is configured to: identify text on the card or voucher picture to obtain a card or voucher issuer name and a card or voucher account, the card or voucher information including the card or voucher issuer name and the card or voucher account.

In another embodiment, the card or voucher obtaining module is configured to: identify text on the card or voucher picture to obtain a card or voucher issuer name and a card or voucher account, and generate a corresponding barcode or two-dimensional barcode according to the card or voucher issuer name and the card or voucher account, the card or voucher information including the card or voucher issuer name and the card or voucher account.

In the foregoing card or voucher sharing apparatus, card or voucher information is stored in the terminal in a form of electronic data by photographing the physical card or voucher.

Still refer to FIG. 21, the list obtaining module includes an identifier obtaining module and an arranging module.

The identifier obtaining module is configured to obtain each user identifier and/or group identifier associated with the sharing initiator identifier.

The arranging module is configured to form the list of associated users according to user information of the user identifier and/or the group identifier.

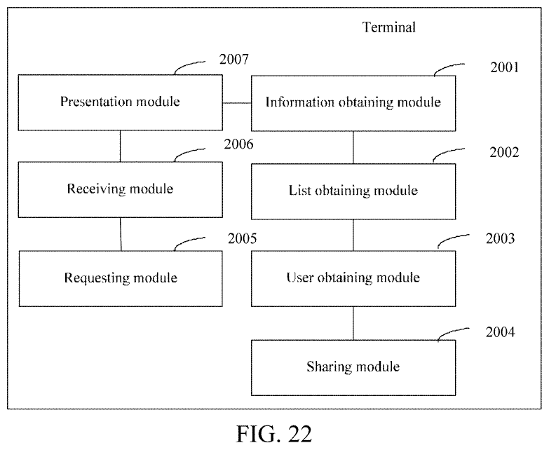

In still another embodiment, as shown in FIG. 22, the service processing apparatus further includes a requesting module 2005, a receiving module 2006, and a presentation module 2007.

The requesting module 2005 is configured to send a data request to the server when receiving an instruction for refreshing a card or voucher.

The receiving module 2006 is configured to receive card or voucher information and a sharing initiator identifier sent by the server in response to the data request.

The presentation module 2007 is configured to present the received card or voucher information and sharing initiator identifier.

In the card or voucher sharing apparatus of this embodiment, the sharing terminal further receive a card or voucher shared by another user terminal.

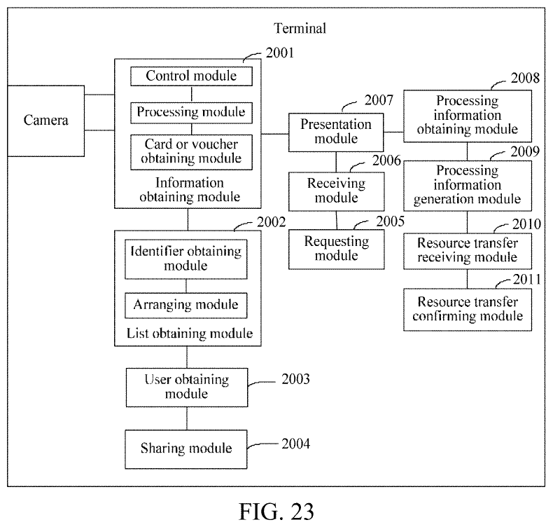

In another embodiment, as shown in FIG. 23, the service processing apparatus further includes:

a processing information obtaining module 2008, configured to obtain a card or voucher account, a consumer identifier, and a cardholder identifier when obtaining an instruction for processing a received card or voucher, the cardholder identifier corresponding to the card or voucher account;

a processing information generation module 2009, configured to generate resource information according to the card or voucher account, the consumer identifier, and the cardholder identifier, a resource receiving terminal obtaining a transfer value and the resource information, subtracting the transfer value from a balance corresponding to the card or voucher account to obtain a service processing result, and sending resource transfer information to a server end according to the service processing result, the resource transfer information including the transfer value, the consumer identifier, and the cardholder identifier;

a resource transfer receiving module 2010, configured to receive a resource transfer request sent by the server end according to the resource transfer information when the consumer identifier is inconsistent with the cardholder identifier, the resource transfer request including the transfer value and the cardholder identifier; and

a resource transfer confirming module 2011, configured to send a resource transfer confirmation to the server end when receiving an instruction for confirming the resource transfer request, the server end subtracting the transfer value from an account balance corresponding to the consumer identifier, and adding the transfer value to an account balance corresponding to the cardholder identifier.

In another embodiment, the processing information generation module 2009 generates a two-dimensional barcode and/or a barcode according to the card or voucher account, the consumer identifier, and the cardholder identifier, the resource information including the two-dimensional barcode and/or the barcode.

In another embodiment, a terminal communicates with the resource receiving terminal to send the resource information to the resource receiving terminal.

It should be understood that steps in the various embodiments of this application are not necessarily performed in a sequence indicated by the step numbers. Unless explicitly specified in this application, execution of the steps is not strictly limited, and the steps may be performed in other sequences. Moreover, at least some of the steps in each embodiment may include a plurality of sub-steps or a plurality of stages. The sub-steps or stages are not necessarily performed at the same moment but may be performed at different moments. Execution of the sub-steps or stages is not necessarily sequentially performed, but may be performed alternately with other steps or at least some of sub-steps or stages of other steps.

A person of ordinary skill in the art may understand that all or some of the processes of the methods in the foregoing embodiments may be implemented by a computer program instructing relevant hardware. The program may be stored in a non-volatile computer-readable storage medium. When the program runs, the processes of the foregoing methods in the embodiments are performed. Any reference to a memory, a storage, a database, or another medium used in the various embodiments provided herein can include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As an illustration instead of a limitation, the RAM is available in various forms, such as a Static RAM (SRAM), a Dynamic RAM (DRAM), a Synchronous DRAM (SDRAM), a Double Data Rate SDRAM (DDRSDRAM), an Enhanced SDRAM (ESDRAM). Synchronous link (Synchlink) DRAM (SLDRAM), a Rambus Direct RAM (RDRAM), a Direct Rambus Dynamic RAM (DRDRAM), and a Rambus Dynamic RAM (DRAM).

Various technical features in the foregoing embodiments may be combined randomly. For ease of description, possible combinations of various technical features in the foregoing embodiments are not all described. However, the combinations of the technical features should be considered as falling within the scope recorded in this specification provided that the combinations of the technical features are compatible with each other.

The foregoing embodiments only show several implementations of this application and are described in detail, but they should not be construed as a limit to the patent scope of this application. It should be noted that, a person of ordinary skill in the art may make various changes and improvements without departing from the ideas of this application, which shall all fall within the protection scope of this application. Therefore, the protection scope of the patent of this application shall be subject to the appended claims.

What is claimed is:

1. A service processing method performed at a terminal having one or more processors and memory storing programs to be executed by the one or more processors, the method comprising:
obtaining, by the terminal, card or voucher information and a sharing initiator identifier when receiving a request for sharing a card or voucher from a user of a social network application;
obtaining, by the terminal, a list of associated users of the social network application, the list of associated users comprising each piece of user information having an association with the sharing initiator identifier and being friends of the user;
obtaining, by the terminal, a sharer identifier selected by using the list of associated users; and
sending, by the terminal, the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

2. The service processing method according to claim 1, wherein the obtaining, by the terminal, card or voucher information and a sharing initiator identifier when receiving a request for sharing a card or voucher from a user of a social network application comprises:
obtaining, by the terminal, the sharing initiator identifier and turning on a camera when receiving the request for sharing a card or voucher;
receiving, by the terminal, a photographing instruction;
obtaining, according to the photographing instruction, a card or voucher picture obtained by photographing a physical card or voucher; and
obtaining, by the terminal, the card or voucher information according to the card or voucher picture.

3. The service processing method according to claim 2, wherein the obtaining, by the terminal, the card or voucher information according to the card or voucher picture comprises:
identifying, by the terminal, text on the card or voucher picture to obtain a card or voucher issuer name and a card or voucher account, the card or voucher information comprising the card or voucher issuer name and the card or voucher account.

4. The service processing method according to claim 2, wherein the obtaining, by the terminal, the card or voucher information according to the card or voucher picture comprises:
identifying, by the terminal, text on the card or voucher picture to obtain a card or voucher issuer name and a card or voucher account; and
generating, by the terminal, a corresponding barcode or two-dimensional barcode according to the card or voucher issuer name and the card or voucher account, the card or voucher information comprising the barcode or the two-dimensional barcode.

5. The service processing method according to claim 1, wherein the obtaining, by the terminal, a list of associated users of the social network application comprises:
obtaining, by the terminal, each user identifier and/or group identifier associated with the sharing initiator identifier; and
forming, by the terminal, the list of associated users according to user information of the user identifier and/or the group identifier.

6. The service processing method according to claim 1, further comprising:
sending, by the terminal, a data request to the server when receiving an instruction for refreshing a card or voucher;
receiving, by the terminal, card or voucher information and a sharing initiator identifier sent by the server in response to the data request; and
presenting, by the terminal, the received card or voucher information and sharing initiator identifier.

7. The service processing method according to claim 1, further comprising:
obtaining, by the terminal, a card or voucher account, a consumer identifier, and a cardholder identifier when obtaining an instruction for processing a received card or voucher, the cardholder identifier corresponding to the card or voucher account;
generating, by the terminal, resource information according to the card or voucher account, the consumer identifier, and the cardholder identifier, a resource receiving terminal obtaining a transfer value and the resource information, subtracting the transfer value from a balance corresponding to the card or voucher account to obtain a service processing result, and sending resource transfer information to a server end according to the service processing result, the resource transfer information comprising the transfer value, the consumer identifier, and the cardholder identifier;
receiving, by the terminal, a resource transfer request sent by the server end according to the resource transfer information when the consumer identifier is inconsistent with the cardholder identifier, the resource transfer request comprising the transfer value and the cardholder identifier; and
sending, by the terminal, a resource transfer confirmation to the server end when receiving an instruction for confirming the resource transfer request, the server end subtracting the transfer value from an account balance corresponding to the consumer identifier, and adding the transfer value to an account balance corresponding to the cardholder identifier.

8. The service processing method according to claim 7, wherein the generating, by the terminal, resource information according to the card or voucher account, the consumer identifier, and the cardholder identifier comprises:
generating, by the terminal, a two-dimensional barcode and/or a barcode according to the card or voucher account, the consumer identifier, and the cardholder identifier, the resource information comprising the two-dimensional barcode and/or the barcode.

9. The service processing method according to claim 7, further comprising:
communicating, by the terminal, with the resource receiving terminal to send the resource information to the resource receiving terminal.

10. A terminal comprising one or more processors, memory coupled to the one or more processors and a plurality of programs stored in the memory that, when executed by the one or more processors, cause the computing device to perform a plurality of operations comprising:
obtaining, by the terminal, card or voucher information and a sharing initiator identifier when receiving a request for sharing a card or voucher from a user of a social network application;
obtaining, by the terminal, a list of associated users of the social network application, the list of associated users comprising each piece of user information having an association with the sharing initiator identifier and being friends of the user;
obtaining, by the terminal, a sharer identifier selected by using the list of associated users; and
sending, by the terminal, the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

11. The terminal according to claim 10, wherein the obtaining, by the terminal, card or voucher information and a sharing initiator identifier when receiving a request for sharing a card or voucher from a user of a social network application comprises:
obtaining, by the terminal, the sharing initiator identifier and turning on a camera when receiving the request for sharing a card or voucher;
receiving, by the terminal, a photographing instruction;
obtaining, according to the photographing instruction, a card or voucher picture obtained by photographing a physical card or voucher; and
obtaining, by the terminal, the card or voucher information according to the card or voucher picture.

12. The terminal according to claim 11, wherein the obtaining, by the terminal, the card or voucher information according to the card or voucher picture comprises:
identifying, by the terminal, text on the card or voucher picture to obtain a card or voucher issuer name and a card or voucher account, the card or voucher information comprising the card or voucher issuer name and the card or voucher account.

13. The terminal according to claim 11, wherein the obtaining, by the terminal, the card or voucher information according to the card or voucher picture comprises:
identifying, by the terminal, text on the card or voucher picture to obtain a card or voucher issuer name and a card or voucher account; and
generating, by the terminal, a corresponding barcode or two-dimensional barcode according to the card or voucher issuer name and the card or voucher account, the card or voucher information comprising the barcode or the two-dimensional barcode.

14. The terminal according to claim 10, wherein the obtaining, by the terminal, a list of associated users of the social network application comprises:
obtaining, by the terminal, each user identifier and/or group identifier associated with the sharing initiator identifier; and
forming, by the terminal, the list of associated users according to user information of the user identifier and/or the group identifier.

15. The terminal according to claim 10, wherein the operations further comprise:
sending, by the terminal, a data request to the server when receiving an instruction for refreshing a card or voucher;
receiving, by the terminal, card or voucher information and a sharing initiator identifier sent by the server in response to the data request; and
presenting, by the terminal, the received card or voucher information and sharing initiator identifier.

16. The terminal according to claim 10, wherein the operations further comprise:
obtaining, by the terminal, a card or voucher account, a consumer identifier, and a cardholder identifier when obtaining an instruction for processing a received card or voucher, the cardholder identifier corresponding to the card or voucher account;
generating, by the terminal, resource information according to the card or voucher account, the consumer identifier, and the cardholder identifier, a resource receiving terminal obtaining a transfer value and the resource information, subtracting the transfer value from a balance corresponding to the card or voucher account to obtain a service processing result, and sending resource transfer information to a server end according to the service processing result, the resource transfer information comprising the transfer value, the consumer identifier, and the cardholder identifier;
receiving, by the terminal, a resource transfer request sent by the server end according to the resource transfer information when the consumer identifier is inconsistent with the cardholder identifier, the resource transfer request comprising the transfer value and the cardholder identifier; and
sending, by the terminal, a resource transfer confirmation to the server end when receiving an instruction for confirming the resource transfer request, the server end subtracting the transfer value from an account balance corresponding to the consumer identifier, and adding the transfer value to an account balance corresponding to the cardholder identifier.

17. The service processing method according to claim 7, wherein the generating, by the terminal, resource information according to the card or voucher account, the consumer identifier, and the cardholder identifier comprises:
generating, by the terminal, a two-dimensional barcode and/or a barcode according to the card or voucher account, the consumer identifier, and the cardholder identifier, the resource information comprising the two-dimensional barcode and/or the barcode.

18. The service processing method according to claim 7, wherein the operations further comprise:
communicating, by the terminal, with the resource receiving terminal to send the resource information to the resource receiving terminal.

19. A non-transitory computer readable storage medium storing a plurality of machine readable instructions in connection with a terminal having one or more processors, wherein the plurality of machine readable instructions, when executed by the one or more processors, cause the terminal to perform a plurality of operations including:
obtaining, by the terminal, card or voucher information and a sharing initiator identifier when receiving a request for sharing a card or voucher from a user of a social network application;
obtaining, by the terminal, a list of associated users of the social network application, the list of associated users comprising each piece of user information having an association with the sharing initiator identifier and being friends of the user;
obtaining, by the terminal, a sharer identifier selected by using the list of associated users; and
sending, by the terminal, the card or voucher information, the sharing initiator identifier, and the sharer identifier to a server based on a sharing instruction, the server sending the card or voucher information and the sharing initiator identifier to a terminal of one of the associated users corresponding to the sharer identifier when a card or voucher information sending condition is satisfied.

20. The non-transitory computer readable storage medium according to claim 19, wherein the obtaining, by the terminal, card or voucher information and a sharing initiator identifier when receiving a request for sharing a card or voucher from a user of a social network application comprises:
obtaining, by the terminal, the sharing initiator identifier and turning on a camera when receiving the request for sharing a card or voucher;
receiving, by the terminal, a photographing instruction;
obtaining, according to the photographing instruction, a card or voucher picture obtained by photographing a physical card or voucher; and
obtaining, by the terminal, the card or voucher information according to the card or voucher picture.
